(19) United States
(12) Patent Application Publication
(10) Pub. No.: US 2008/0197196 A1
(43) Pub. Date: Aug. 21, 2008

(54) Barcode scanner

(75) Inventors: Kenneth Liou, Hsin-Tien City (TW); Ting-Hao Hsiao, Hsin-Tien City (TW)

Correspondence Address: MARSON Technology Co., Ltd., P. O. Box No. 6-57, Junghe, Taipei 235, omitted

(73) Assignee: MARSON Technology Co., Ltd., Hsin-Tien City (TW)

(21) Appl. No.: 11/707,928

(22) Filed: Feb. 20, 2007

(51) Int. Cl. G06K 7/10

(52) U.S. Cl. 235/462.01

(57) ABSTRACT

A barcode scanner includes primarily a machine body and a light source mechanism. An interior of the machine body contains a holding space, and a front end of the machine body consists of a light access. The light source mechanism is installed in the holding space of the machine body, and contains a light source, a condenser, a lens, a photo-induced receiver, and a reflector. The condenser is located at a front end of the light source, the lens is located at one side of the light source, the photo-induced receiver is located at a rear side of the lens, and the reflector is located at a proper distance to a front of the condenser and the lens. Accordingly, an effect of barcode scanning is improved, a range of visual angles covered by the light source is enlarged, power consumption is lowered, cost is saved, and assembling is facilitated.

### BACKGROUND OF THE INVENTION

a) Field of the Invention

The present invention relates to a barcode scanner, and more particularly to a barcode scanner wherein a great barcode scanning effect can be achieved, a range of visual angles covered by a light source can be enlarged, power consumption can be lowered, cost can be saved, and an installation can be convenient by an assembly design of a machine body and a light source mechanism, thereby being able to be applied to all kinds of barcode scanners or similar products.

b) Description of the Prior Art

A conventional barcode scanner includes primarily a machine body 10a and a light source mechanism 20a (as shown in FIG. 1 and FIG. 2). An interior of the machine body 10a is provided with a holding space 11a, and a front end of the machine body 10a is provided with a light access 12a. The light source mechanism 20a is installed in the holding space 11a of the machine body 10a, and is provided with a light source 21a, a condenser 22a, a lens 23a, a photo-induced receiver 24a, and a reflector 25a. The light source 21a and the condenser 22a are close to the light access 12a at the front end of the machine body 10a, the condenser 22a is at a front end of the light source 21a, and the lens 23a is close to a center of the machine body 10a. The photo-induced receiver 24a is at a rear side of the lens 23a, and the reflector 25a is at a proper distance to a front of the lens 23a to reflect and transmit data on a barcode 30a, thereby achieving objects of fast speed, accuracy, and man-power saving. Although the barcode scanner is provided with the effects of fast speed, accuracy, and man-power saving, as the light source 21a and the condenser 22a are close to the light access 12a at the front end of the machine body 10a, entire structure is more complicated, and an effective optical receiving range of the light source 21a is limited. On the other hand, another kind of barcode scanner includes primarily a machine body 10b and a light source mechanism 20b (as shown in FIGS. 3 to 5). An interior of the machine body 10b is provided with a holding space 11b, and a front end of the machine body 10b is provided with a light access 12b. The light source mechanism 20b is installed in the holding space 11b of the machine, body 10b, and is provided with two light sources 21b, two condensers 22b, one lens 23b, one photo-induced receiver 24b, and one reflector 25b. Each condenser 22b is located at a front end of each light source 21b, and is at a distance normally greater than 10 mm to the front end of each light source 21b; whereas the lens 23b is located at a center in a front of the two light sources 21b, such that a range of reflection angles received by the lens 23b can cover a total scanning angle of the two light sources 21b. Moreover, the photo-induced receiver 24b is located at a rear side of the lens 23b, and the reflector 25b is located at a proper distance to a front of the condensers 22b and the lens 23b for interpreting data on a barcode 30b, thereby achieving the objects of fast speed, accuracy, and man-power saving. Although the barcode is also provided with the same effects of fast speed, accuracy, and man-power saving, as a range of required visual angles of the condensers 22b cannot be covered by one light source 21b, and two light sources 21b at the left and right sides are needed to mutually compensate insufficient parts of the visual angles; power consumption is higher, cost of parts and cost in assembling are increased, and size of the entire structure of the light source mechanism 20b is larger, which relatively increases size of the holding space 11b of the machine body 10b. In addition, as each condenser 22b is located at a distance of normally greater than 10 mm to the front end of each light source 21b, length of each condenser 22b needs to be increased relatively to sufficiently condense the light, thereby increasing the cost of entire structure. Moreover, the scanning angles of the two light sources 21b are provided with an overlapped area, which results in uneven brightness of reflected optical signals of the barcode, and is easy to create an error in interpreting the barcode. Accordingly, it is still not in compliance with a user's requirement in practical application.

### SUMMARY OF THE INVENTION

The primary object of present invention is to provide a barcode scanner, wherein by an assembly design of a machine body and a light source mechanism, a condenser is located at a distance of less than 3.0 mm to a front end of the light source, such that the condenser is very close to the light source; therefore, the condenser can collect light emitted by the light source with larger angles and then emit scanning beams, so as to improve an interpretation efficiency of the barcode and to shorten length of the condenser at the same time, for decreasing cost, thereby being provided with effects of a great optical interpretation efficiency and a reduction of the cost, to increase practicability of the entire structure.

Another object of the present invention is to provide a barcode scanner, wherein by installing a lens at a side of the light source, and having a very small space between the light source and the lens, position of the lens will enable scanning angles of the light source to cover a range of all receivable visual angles of the lens; therefore, the light of the light source will not be branched out due to a change of distance to the barcode, which enables the light source to keep on irradiating at a receiving range of the visual angles of the lens, thereby having a larger range of visual angles covered by the light source to increase functions of the entire structure.

Still another object of the present invention is to provide a barcode scanner, wherein by installing only one light source for the light source mechanism, a good barcode scanning effect can be achieved; therefore, power consumption can be lowered, and the structure can be simplified, thereby saving cost of parts and cost in assembling, to increase the practicability and convenience of the entire structure.

Yet still another object of the present invention is to provide a barcode scanner, wherein by having small size of the entire structure of the light source mechanism, the light source mechanism can be easily installed in a mechanism or environment of limited space, to increase convenience in assembling and versatility.

Accordingly, the present invention is a barcode scanner which includes a machine body and a light source mechanism, wherein an interior of the machine body is provided with a holding space and a front end of the machine body is provided with a light access; and the light source mechanism is installed in the holding space of the machine body and is provided with a light source, a condenser, a lens, a photo-induced receiver, and a reflector. The condenser is located at a front end of the light source and is at a distance of less than 3.0 mm to the front end of the light source, the lens is located at a side of the light source, the photo-induced receiver is located at a rear side of the lens, and the reflector is located at a proper distance to a front of the condenser and the lens, thereby providing a perfect barcode scanning effect, enlarging a range of visual angles covered by the light source, lowering power consumption, saving cost, facilitating assembling, and increasing the practicability and convenience of the entire structure.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a side cutaway view of a prior art.

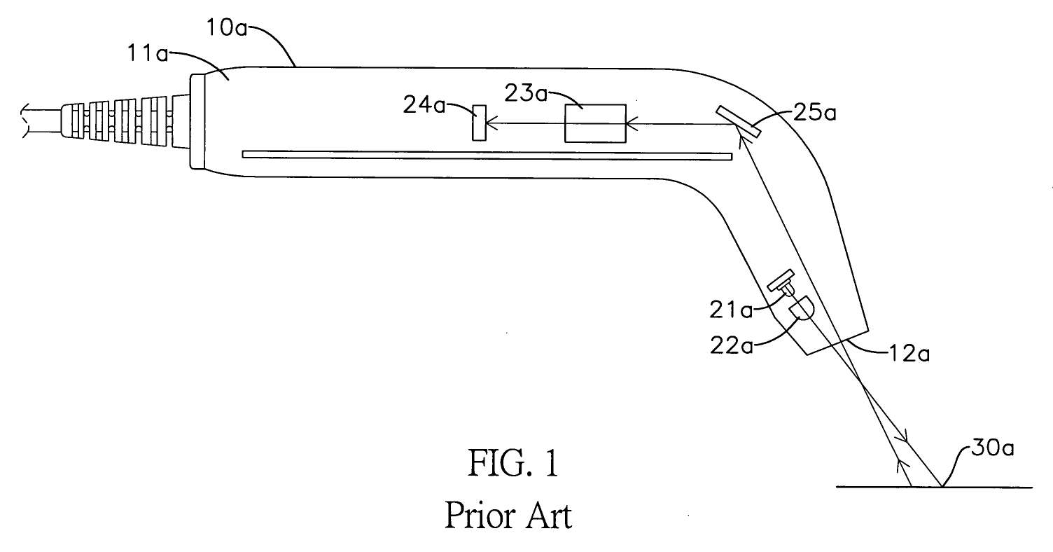

FIG. 2 shows a top cutaway view of a prior art.

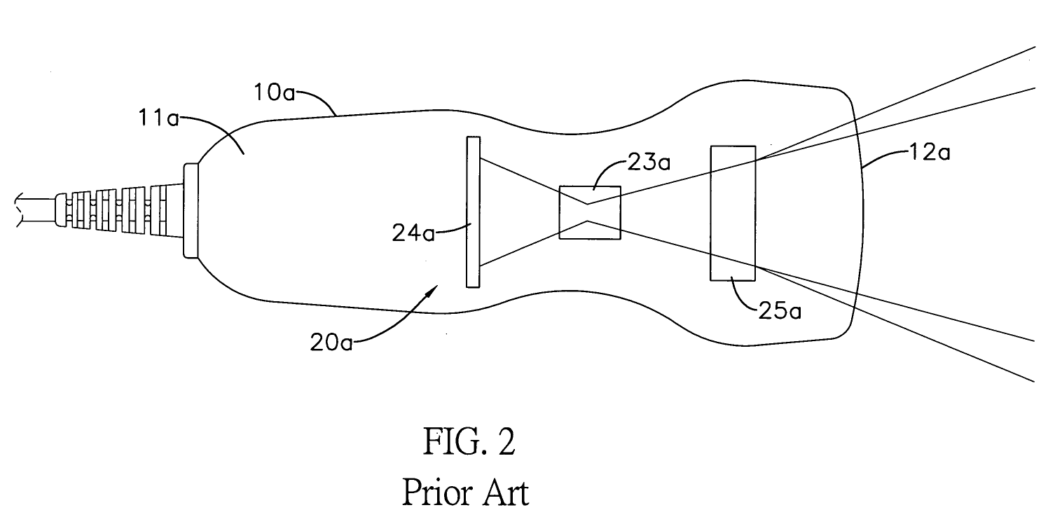

FIG. 3 shows a side cutaway view of another prior art.

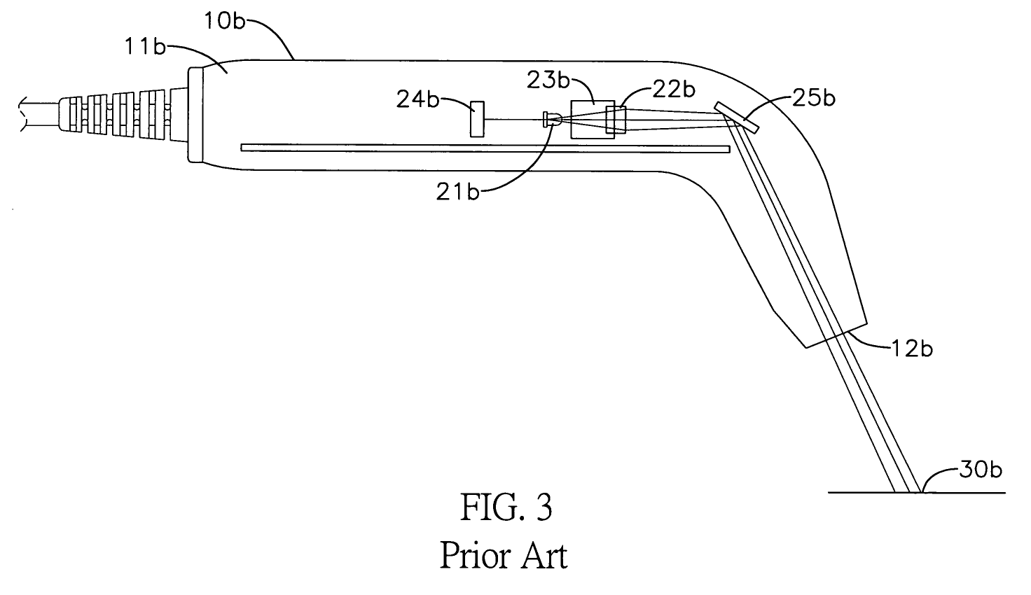

FIG. 4 shows a top cutaway view of another prior art.

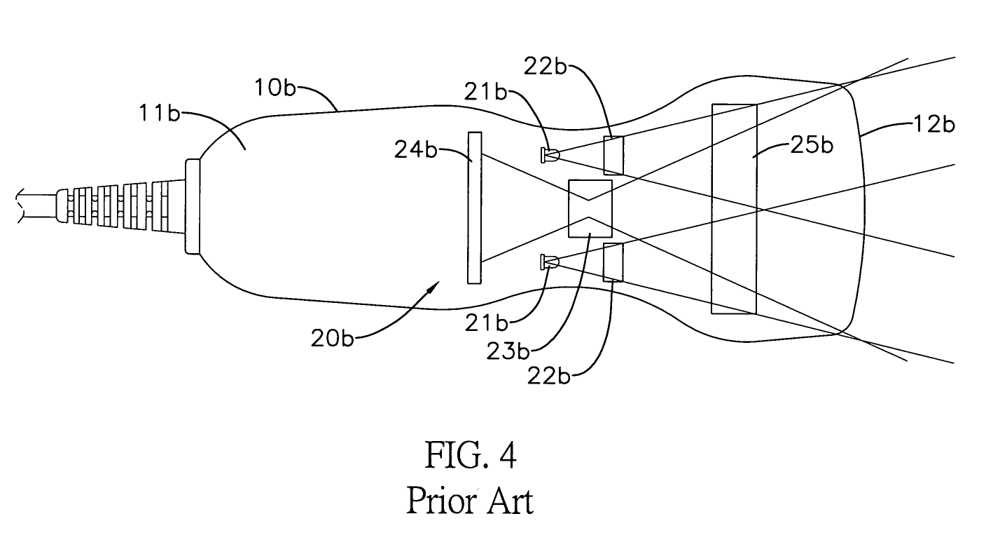

FIG. 5 shows a schematic view of an angle of converging light of another prior art

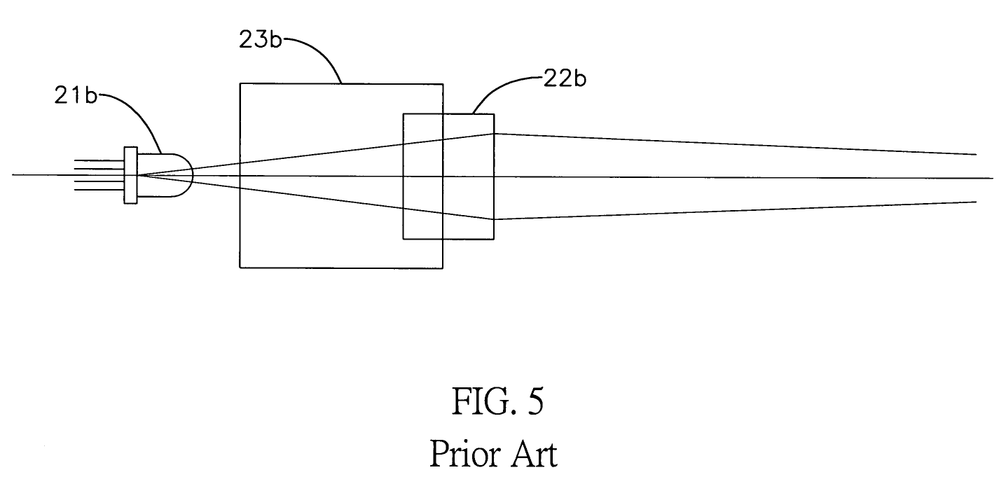

FIG. 6 shows a side cutaway view of the present invention.

FIG. 7 shows a top cutaway view of the present invention.

FIG. 8 shows a schematic view of an angle of converging light of the present invention.

FIG. 9 shows a top cutaway view of another embodiment of the present invention.

### DETAILED DESCRIPTION OF THE PREFERRED EMBODIMENTS

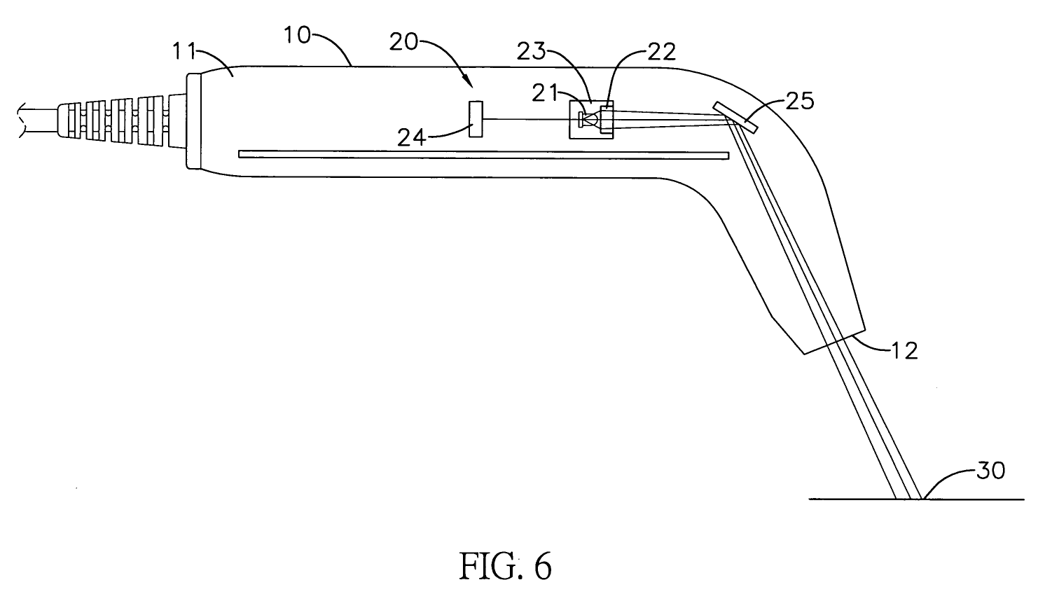

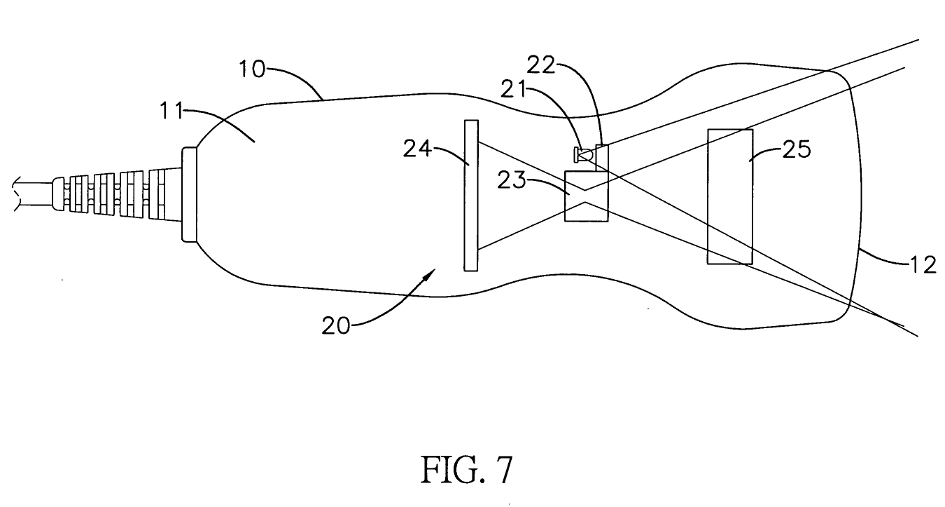

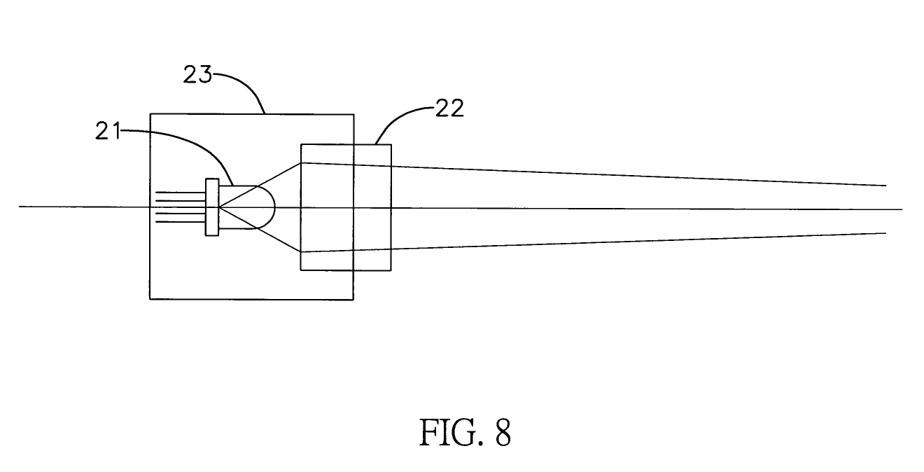

Referring to FIGS. 6 to 8, the present invention is a barcode scanner, which comprises primarily a machine body 10, an interior of which is provided with a holding space 11, and a front end of which is provided with a light access 12; and a light source mechanism 20, which is installed in the holding space 11 of the machine body 10, and is provided with a light source 21, a condenser 22, a lens 23, a photo-induced receiver 24, and a reflector 25. The condenser 22 is located at a front end of the light source 21 (the light source 21 is an LED (Light Emitting Diode)), and is at a distance of less than 3.0 mm to the front end of the light source 21; whereas, the lens 23 is located at a side of the light source 21 and is at a position that enables visual angles of the light source 21 to sufficiently cover a range of all receivable visual angles of the lens 23, the photo-induced receiver 24 is located at a rear side of the lens 23, and the reflector 25 is located at a proper distance to a front of the condenser 22 and the lens 23.

Accordingly, referring to FIGS. 6 to 8, by an assembly design of the machine body 10 and the light source mechanism 20, the condenser 22 is installed at the distance of less than 3.0 mm to the front end of the light source 21, such that the condenser 22 is very close to the light source 21. Therefore, the condenser 22 is able to collect light emitted by the light source 21 in larger angles, and then to irradiate scanning beams, so as to improve efficiency of using the light source and in the mean time to decrease length of the condenser 22, thereby lowering cost. On the other hand, by locating the lens 23 at one side of the light source 21, and having a very small space between the light source 21 and the lens 23, position of the lens 23 will enable scanning angles of the light source 21 to cover a range of all receivable visual angles of the lens 23. Accordingly, the light of the light source 21 will not be branched out from a change of distance to the barcode 30, enabling the light source 21 to keep on irradiating at the range of visual angles of the lens 23. Moreover, as only one light source 21 needs to be installed in the light source mechanism 20, the power consumption is less than that of the prior art where two light sources are installed, which can save about 30 mA of current; and in the mean time, as the structure is simplified, the cost of parts and in assembling can be saved. Furthermore, as size of the entire structure of the light source mechanism 20 is small, the light source mechanism 20 can be easily installed in a mechanism or environment of limited space, so as to increase versatility in assembling, which enables the present invention to be provided with the effects of perfect light efficiency, a large range of visual angles covered by the light source, low power consumption, saving of the cost, and convenience in assembling, thereby increasing the practicability and versatility of the entire structure.

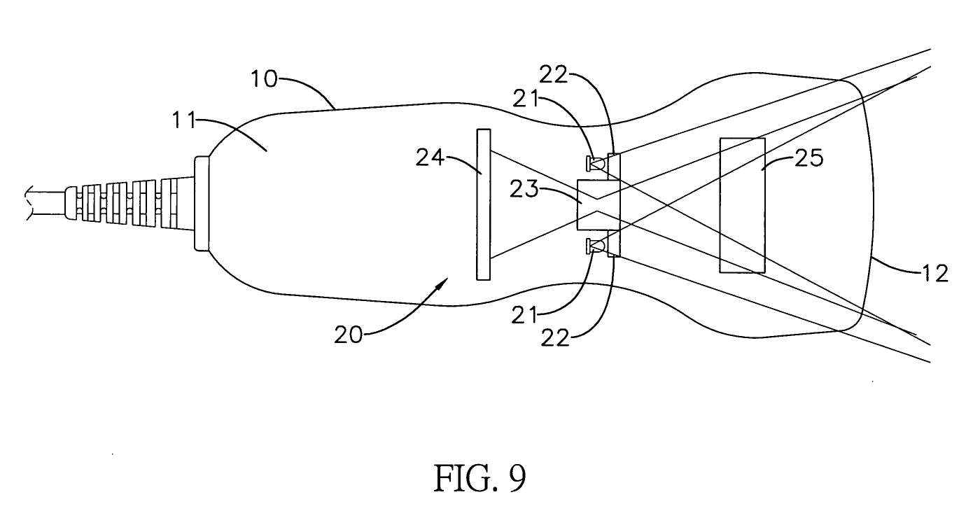

As shown in FIGS. 6 to 8, although the light source mechanism 20 shown in the drawings only includes one light source 21 and one condenser 22, to achieve the perfect light efficiency, the large range of visual angles covered by the light source 21, the low power consumption, the saving of the cost, and the convenience in assembling, in practical application, another light source 21 and condenser 22 (as shown in FIG. 9) can be further added at the other side of the lens 23 of the light source mechanism 20 in a limited size to increase brightness, under a condition that stronger light is required, due to that the size of the entire structure of the light source mechanism 20 is small. In addition, as illumination has been already uniform under one light source 21, it is not necessary to consider an issue of changing the uniformity of the illumination when another light source 21 is added.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A barcode scanner comprising a machine body, an interior of which is provided with a holding space, and a front end of which is provided with a light access; and a light source mechanism, which is installed in the holding space of the machine body, and is provided with a light source, a condenser, a lens, a photo-induced receiver, and a reflector; the condenser being located at a distance of less than 3.0 mm to a front end of the light source, the lens being located at one side of the light source, the photo-induced receiver being located at a rear side of the lens, and the reflector being located at a distance to a front of the condenser and the lens.

2. The barcode scanner according to claim 1, wherein position of the lens, which is located at one side of the light source, enables scanning angles of the light source to cover a range of all receivable visual angles of the lens.

3. The barcode scanner according to claim 1, wherein the other side of the lens of the light source mechanism is further added with another light source and condenser, to increase brightness of barcode scanning signals.

4. The barcode scanner according to claim 1, wherein the light source is an LED (Light Emitting Diode).
